(19) United States
(12) Patent Application Publication
(10) Pub. No.: US 2025/0337135 A1
(43) Pub. Date: Oct. 30, 2025

(54) BONDING METHOD, AND ELECTRICAL ENERGY STORAGE DEVICE AND MANUFACTURING METHOD FOR THE SAME

(71) Applicant: Prime Planet Energy & Solutions, Inc., Tokyo (JP)

(72) Inventor: Shota YAMAMOTO, Kobe-shi (JP)

(21) Appl. No.: 19/185,263

(22) Filed: Apr. 22, 2025

(30) Foreign Application Priority Data
Apr. 25, 2024 (JP) 2024-071790

(51) Int. Cl. H01M 50/566; B23K 26/21; B23K 26/362

(52) U.S. Cl. CPC H01M 50/566; B23K 26/21; B23K 26/362

(57) ABSTRACT

A bonding method disclosed herein includes: a laser welding step of irradiating a boundary portion between a first member made of a metal and a second member made of a metal with laser, thereby forming a welding bonding part; and an etching step of irradiating a surface of the welding bonding part and its peripheral part with an energy beam with lower output than an output in the laser welding step, thereby forming a plurality of concave parts with a substantially circular shape at the surface of the welding bonding part and its peripheral part.

### CROSS REFERENCE TO RELATED APPLICATION

This application claims the benefit of priority to Japanese Patent Application No. 2024-071790 filed on Apr. 25, 2024. The entire contents of this application are hereby incorporated herein by reference.

### BACKGROUND OF THE DISCLOSURE

### 1. Field

The present disclosure relates to a bonding method, and an electrical energy storage device and a manufacturing method for the same.

### 2. Background

Conventionally, in a manufacturing process for an electrical energy storage device and the like, a first member made of a metal and a second member made of a metal are bonded to each other by welding with laser. Conventional technical literatures related to this include WO2010/131298, Japanese Patent No. 6885072, and Japanese Patent Application Publication No. 2016-140877.

### SUMMARY

According to the present inventor's knowledge, when metal members are bonded to each other by welding with laser, molten metal with high temperature may be generated from a welded part as microparticles (so-called weld spatter) and scatter randomly to a surface of a welding bonding part and its peripheral part. Remaining of the weld spatter can result in a trouble such as short-circuit; therefore, it has been demanded to remove the weld spatter efficiently after welding bonding by laser.

The present disclosure has been made in view of the above circumstances, and a main object is to provide a bonding method that leaves the weld spatter less easily.

A bonding method according to the present disclosure includes: a laser welding step of irradiating a boundary portion between a first member made of a metal and a second member made of a metal with laser, thereby forming a welding bonding part; and an etching step of irradiating a surface of the welding bonding part and its peripheral part with an energy beam with lower output than an output in the laser welding step, thereby forming a plurality of concave parts with a substantially circular shape at the surface of the welding bonding part and its peripheral part.

In the present disclosure, the surface of the welding bonding part and its peripheral part are irradiated with the energy beam in the etching step. Thus, the weld spatter that has scattered to the random positions in the laser welding step can be efficiently removed. As a result, the remaining of the weld spatter can be reduced.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating an electrical energy storage device according to an embodiment;

FIG. 2 is a schematic longitudinal cross-sectional view taken along line II-II in FIG. 1;

FIG. 3 is a perspective view schematically illustrating a united object of a sealing plate and an electrode body group;

FIG. 4 is a schematic view illustrating a structure of a winding electrode body;

FIG. 5 is a perspective view schematically illustrating a sealing plate assembly;

FIG. 6 is a perspective view of the sealing plate in FIG. 5 that is turned over;

FIG. 7 is a cross-sectional view taken along line VII-VII in FIG. 5;

FIG. 8 is a partially enlarged plan view schematically illustrating a welding bonding part in FIG. 6 and its vicinity;

FIG. 9 is a partially enlarged view of a roughened part in FIG. 8;

FIG. 10 is a cross-sectional view taken along line X-X in FIG. 9;

FIG. 11 is a diagram corresponding to FIG. 8 according to a modification; and

FIGS. 12A to 12D are observation images of the welding bonding part and its vicinity according to Example.

### DETAILED DESCRIPTION OF THE PREFERRED EMBODIMENTS

Hereinafter, preferred embodiments of the art disclosed herein will be described with reference to the drawings. Meanwhile, matters that are other than matters particularly mentioned in the present specification and that are necessary for the implementation of the present disclosure (for example, the general configuration and manufacturing process of an electrical energy storage device that do not characterize the present disclosure) can be grasped as design matters of those skilled in the art based on the prior art in the relevant field. The present disclosure can be implemented on the basis of the contents disclosed in the present specification and common technical knowledge in the relevant field.

Although a manufacturing method for an electrical energy storage device including a first member made of a metal and a second member made of a metal as constituent elements will be described below as one embodiment of a bonding method disclosed herein, for example, it is not intended to limit the target to which the bonding method disclosed herein is applied to the electrical energy storage device. In the present specification, the notation “A to B” for a range signifies a value more than or equal to A and less than or equal to B, and is meant to encompass also the meaning of being “more than A (over A)” and “less than B (under B)”.

### <Electrical Energy Storage Device>

First, a structure of an electrical energy storage device manufactured by the manufacturing method disclosed herein is described. Note that the term “electrical energy storage device” in this specification refers to general devices that can be repeatedly charged and discharged as a result of the transfer of charge carriers between a positive electrode and a negative electrode through an electrolyte. The electrolyte may be any one of a liquid electrolyte (electrolyte solution), a gel electrolyte, and a solid electrolyte. The electrical energy storage device encompasses secondary batteries such as lithium ion secondary batteries and nickel-hydrogen batteries, and capacitors such as lithium ion capacitors and electrical double-layer capacitors.

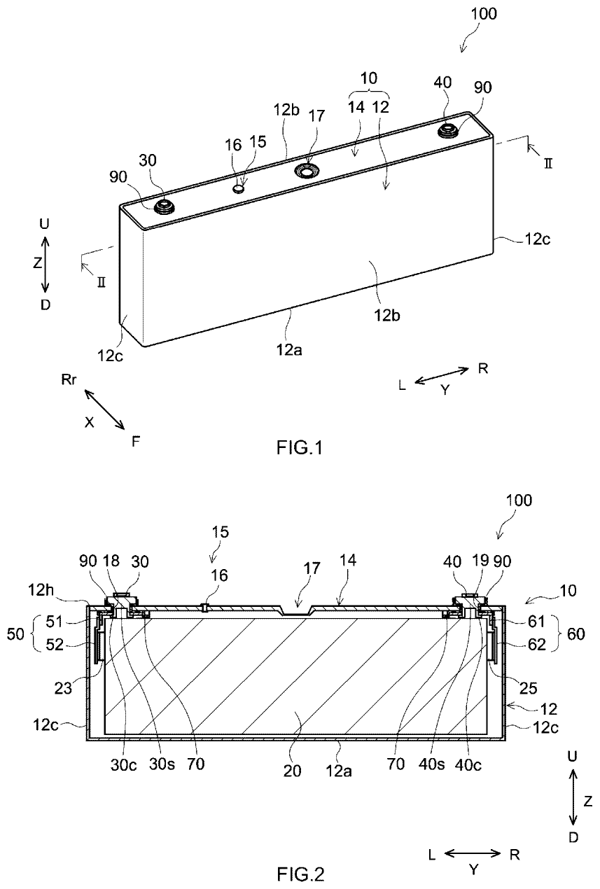

FIG. 1 is a perspective view of an electrical energy storage device 100. FIG. 2 is a schematic longitudinal cross-sectional view taken along line II-II in FIG. 1. In the following description, reference signs L, R, F, Rr, U, and D in the drawings respectively denote left, right, front, rear, up, and down, and reference signs X, Y, and Z in the drawings respectively denote a short side direction of the electrical energy storage device 100, a long side direction that is orthogonal to the short side direction, and an up-down direction that is orthogonal to the short side direction and the long side direction. However, these are merely directions for convenience of description and do not limit the mode of installation of the electrical energy storage device 100.

As illustrated in FIG. 2, the electrical energy storage device 100 includes a case 10, an electrode body group 20, a positive electrode terminal 30, a negative electrode terminal 40, a positive electrode current collecting part 50, and a negative electrode current collecting part 60. Although not illustrated in the drawing, the electrical energy storage device 100 further includes a nonaqueous electrolyte solution here. The electrical energy storage device 100 is configured in such a way that the electrode body group 20 and the nonaqueous electrolyte solution, which is not illustrated, are accommodated in the case 10. The electrical energy storage device 100 is a nonaqueous electrolyte solution secondary battery here, and more specifically, a lithium ion secondary battery.

The case 10 is a housing that accommodates the electrode body group 20 and the nonaqueous electrolyte solution. Here, the case 10 has an outer shape having a flat and bottomed rectangular parallelepiped shape (square shape). The material of the case 10 may be the same as a material that has been used conventionally, and is not particularly limited. The case 10 is preferably formed of a metal and is more preferably formed of, for example, aluminum, an aluminum alloy, iron, an iron alloy, or the like. As illustrated in FIG. 2, the case 10 includes a case main body 12 having an opening 12h, and a sealing plate (lid body) 14 that covers the opening 12h.

As illustrated in FIG. 1, the case main body 12 includes a bottom wall 12a with a substantially rectangular shape, a pair of long side walls 12b that extend from long sides of the bottom wall 12a and face each other, and a pair of short side walls 12c that extend from short sides of the bottom wall 12a and face each other. The area of the short side wall 12c is smaller than the area of the long side wall 12b. Inside the case main body 12, the electrode body group 20 and the nonaqueous electrolyte solution are accommodated. Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

The sealing plate 14 is a plate-shaped member with predetermined thickness. The sealing plate 14 is attached to the case main body 12 so as to cover the opening 12h of the case main body 12. The sealing plate 14 faces the bottom wall 12a of the case main body 12. The sealing plate 14 has a substantially rectangular shape in a plan view. The case 10 is integrated by the sealing plate 14 being bonded (for example, bonded by welding) to a periphery of the opening 12h of the case main body 12. The case 10 is hermetically sealed (closed).

As illustrated in FIG. 2, the sealing plate 14 is provided with a liquid injection hole 15, a gas exhaust valve 17, and two terminal extraction holes 18 and 19. The liquid injection hole 15 is a hole for injecting the nonaqueous electrolyte solution into the case 10 after the sealing plate 14 is assembled to the case main body 12. The liquid injection hole 15 is sealed by a sealing member 16. The gas exhaust valve 17 is configured to fracture when pressure inside the case 10 reaches a predetermined value or more and discharge a gas in the case 10 to the outside. The terminal extraction holes 18 and 19 are formed in both end parts of the sealing plate 14 in the long side direction Y. The terminal extraction holes 18 and 19 penetrate the sealing plate 14 in the up-down direction Z. The terminal extraction holes 18 and 19 have a cylindrical shape here. The terminal extraction holes 18 and 19 respectively have inner diameters that enable penetration of the positive electrode terminal 30 and the negative electrode terminal 40 before the electrode terminals are attached to the sealing plate 14 (before a caulking process). For example, the terminal extraction hole 18 is formed to be smaller than a shaft part 30a of the positive electrode terminal 30, which is described below, before the caulking process.

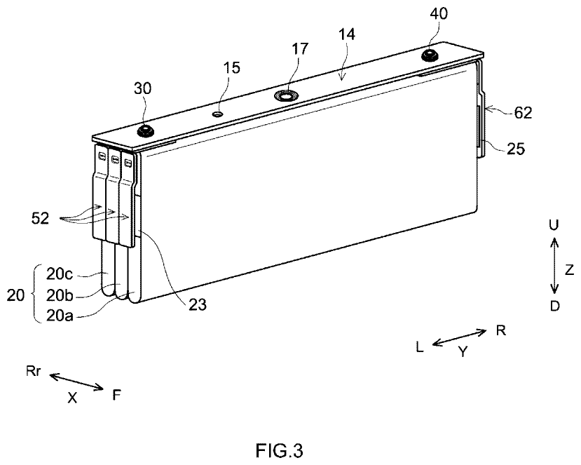

FIG. 3 is a perspective view schematically illustrating a united object of the sealing plate 14 (specifically, sealing plate assembly to be described below) and the electrode body group 20. Here, the electrode body group 20 includes three electrode bodies 20a, 20b, and 20c. However, the number of electrode bodies disposed inside one case 10 is not particularly limited, and may be one, or two or more (plural). The structure of each of the electrode bodies 20a, 20b, and 20c is not limited in particular and may be similar to the conventional one.

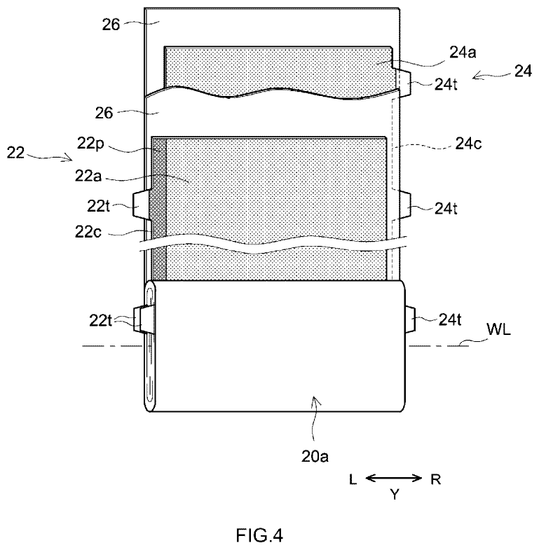

FIG. 4 is a schematic view illustrating a structure of the electrode body 20a. Although the electrode body 20a will be described below in detail as an example, the electrode bodies 20b and 20c can also be configured similarly. The electrode body 20a includes a positive electrode 22 and a negative electrode 24. The positive electrode 22 and the negative electrode 24 are one example of a first electrode and a second electrode disclosed herein. Here, the electrode body 20a is a flat winding electrode body in which the positive electrode 22 with a band shape and the negative electrode 24 with a band shape are stacked through two separators 26 with a band shape and are wound using a winding axis WL as a center. However, each of the electrode bodies 20a, 20b, and 20c may be a laminated electrode body in which a positive electrode with a square shape (typically rectangular shape) and a negative electrode with a square shape (typically rectangular shape) are laminated on each other in an insulated state.

As can be understood from FIG. 2 and FIG. 4, the electrode body 20a is disposed inside the case 10 in a direction in which the winding axis WL is parallel to the long side direction Y. In other words, the electrode body 20a is disposed inside the case 10 in a direction in which the winding axis WL is parallel to the bottom wall 12a and orthogonal to the short side wall 12c. The electrical energy storage device 100 has a so-called lateral tab structure in which a positive electrode tab group 23 and a negative electrode tab group 25 to be described below exist respectively on a left side and a right side of the electrode body group 20 as illustrated in FIG. 2. However, the electrical energy storage device 100 may have a so-called upper tab structure in which the positive electrode tab group 23 and the negative electrode tab group 25 exist respectively on an upper side and a lower side of the electrode body group 20.

As illustrated in FIG. 4, here, the positive electrode 22 includes a positive electrode current collector 22c, and a positive electrode active material layer 22a and a positive electrode protection layer 22p that are firmly fixed onto at least one surface of the positive electrode current collector 22c. However, the positive electrode protection layer 22p is not an essential component and can also be omitted in other embodiments. The positive electrode current collector 22c has a band shape. The positive electrode current collector 22c is formed of a conductive metal such as aluminum, an aluminum alloy, nickel, or stainless steel. Here, the positive electrode current collector 22c is a metal foil, specifically an aluminum foil.

A plurality of positive electrode tabs 22t are provided at one end part (the left end part in FIG. 4) of the positive electrode current collector 22c in the long side direction Y. Each of the plurality of positive electrode tabs 22t has a convex shape protruding toward one side (the left side in FIG. 4) in the long side direction Y. The plurality of positive electrode tabs 22t are provided at intervals (intermittently) in the longitudinal direction of the positive electrode 22. Here, the positive electrode tab 22t is a part of the positive electrode current collector 22c and is formed of a metal foil (aluminum foil). The positive electrode tab 22t is a part (current collector exposed part) of the positive electrode current collector 22c in which the positive electrode active material layer 22a and the positive electrode protection layer 22p are not formed. However, the positive electrode tab 22t may be a member separate from the positive electrode current collector 22c. As illustrated in FIG. 2, the plurality of positive electrode tabs 22t are stacked at one end part (the left end part in FIG. 4) in the long side direction Y and constitute the positive electrode tab group 23. The positive electrode tab group 23 is electrically connected to the positive electrode terminal 30 through the positive electrode current collecting part 50. A positive electrode second current collecting part 52 to be described below is attached to the positive electrode tab group 23.

As illustrated in FIG. 4, the positive electrode active material layer 22a is provided to have a band shape in the longitudinal direction of the positive electrode current collector 22c with a band shape. The positive electrode active material layer 22a contains a positive electrode active material (for example, a lithium transition metal complex oxide such as a lithium nickel cobalt manganese complex oxide) capable of reversibly storing and releasing charge carriers. The positive electrode active material layer 22a may additionally contain any component other than the positive electrode active material, for example, a conductive material, a binder, various additive components, or the like.

As illustrated in FIG. 4, the positive electrode protection layer 22p is provided at a boundary portion between the positive electrode current collector 22c and the positive electrode active material layer 22a in the long side direction Y. Here, the positive electrode protection layer 22p is provided at one end part (the left end part in FIG. 4) of the positive electrode current collector 22c in the long side direction Y. The positive electrode protection layer 22p is provided to have a band shape along the positive electrode active material layer 22a. The positive electrode protection layer 22p contains an inorganic filler (for example, alumina). The positive electrode protection layer 22p may additionally contain any component other than the inorganic filler, for example, a conductive material, a binder, various additive components, or the like.

As illustrated in FIG. 4, the negative electrode 24 includes a negative electrode current collector 24c and a negative electrode active material layer 24a that is firmly fixed onto at least one surface of the negative electrode current collector 24c here. The negative electrode current collector 24c has a band shape. The negative electrode current collector 24c is formed of a conductive metal such as copper, a copper alloy, nickel, or stainless steel. Here, the negative electrode current collector 24c is a metal foil, specifically a copper foil.

A plurality of negative electrode tabs 24t are provided at one end part (the right end part in FIG. 4) of the negative electrode current collector 24c in the long side direction Y. Each of the plurality of negative electrode tabs 24t has a convex shape protruding toward one side (the right side in FIG. 4) in the long side direction Y. The plurality of negative electrode tabs 24t are provided at intervals (intermittently) in the longitudinal direction of the negative electrode 24. Here, the negative electrode tab 24t is a part of the negative electrode current collector 24c and is formed of a metal foil (copper foil). The negative electrode tab 24t is a part (current collector exposed part) of the negative electrode current collector 24c in which the negative electrode active material layer 24a is not formed. However, the negative electrode tab 24t may be a member separate from the negative electrode current collector 24c. As illustrated in FIG. 2, the plurality of negative electrode tabs 24t are laminated at one end part (the right end part in FIG. 4) in the long side direction Y and constitute the negative electrode tab group 25. The negative electrode tab group 25 is electrically connected to the negative electrode terminal 40 through the negative electrode current collecting part 60. A negative electrode second current collecting part 62 to be described below is attached to the negative electrode tab group 25.

As illustrated in FIG. 4, the negative electrode active material layer 24a is provided to have a band shape in the longitudinal direction of the negative electrode current collector 24c with a band shape. The negative electrode active material layer 24a contains a negative electrode active material (for example, a carbon material such as graphite) capable of reversibly storing and releasing charge carriers. The negative electrode active material layer 24a may additionally contain any component other than the negative electrode active material, for example, a binder, a dispersant, various additive components, or the like.

The separator 26 is a member that insulates the positive electrode active material layer 22a of the positive electrode 22 and the negative electrode active material layer 24a of the negative electrode 24 from each other. As the separator 26, for example, a porous resin sheet formed of a polyolefin resin such as polyethylene (PE) or polypropylene (PP) is suitable. Meanwhile, a functional layer such as an adhesive layer containing a binder or a heat resistance layer (HRL) containing an inorganic filler may be provided on a surface of the separator 26.

The nonaqueous electrolyte solution may be similar to that in the related art and is not particularly limited. The nonaqueous electrolyte solution typically contains a nonaqueous solvent and a supporting salt. The nonaqueous solvent contains, for example, carbonates such as ethylene carbonate, dimethyl carbonate, and ethyl methyl carbonate. The supporting salt is, for example, a fluorine-containing lithium salt such as LiPF₆. In another embodiment, however, the electrical energy storage device 100 may include an aqueous electrolyte solution, a gel-state electrolyte, a solid-state electrolyte (solid electrolyte), or the like as the electrolyte instead of the nonaqueous electrolyte solution.

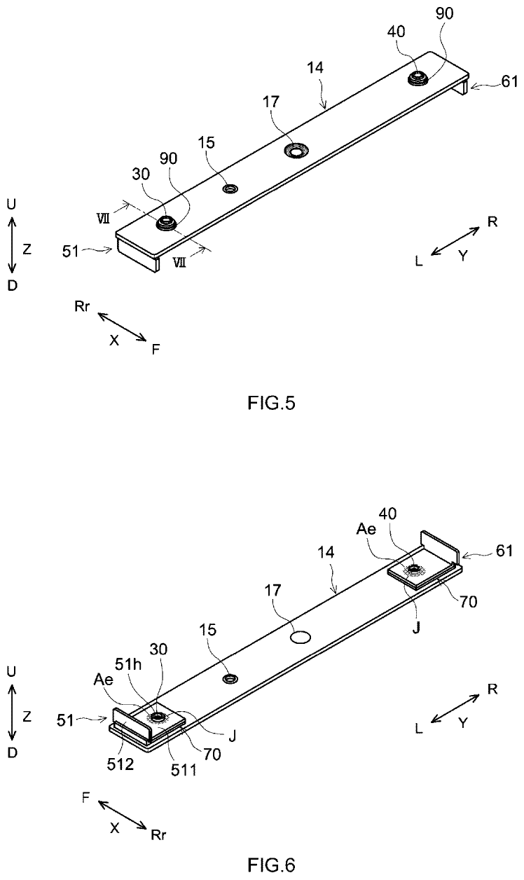

FIG. 5 is a perspective view schematically illustrating the sealing plate assembly. FIG. 6 is a perspective view in which the sealing plate 14 in FIG. 5 is turned over. FIG. 6 illustrates a surface (inner surface) of the sealing plate 14 on the side of the case main body 12. The sealing plate assembly is, here, a united object of the sealing plate 14, the positive electrode terminal 30, the negative electrode terminal 40, a positive electrode first current collecting part 51 of the positive electrode current collecting part 50, a negative electrode first current collecting part 61 of the negative electrode current collecting part 60, two resin members 70, and two gaskets 90. In the sealing plate assembly, the positive electrode terminal 30, the gasket 90, the positive electrode first current collecting part 51 of the positive electrode current collecting part 50, and the resin member 70 are integrated with the sealing plate 14 in such a way that the positive electrode terminal 30 is caulked and bonded by welding to the positive electrode first current collecting part 51. Similarly, the negative electrode terminal 40, the gasket 90, the negative electrode first current collecting part 61 of the negative electrode current collecting part 60, and the resin member 70 are integrated with the sealing plate 14 in such a way that the negative electrode terminal 40 is caulked and bonded by welding to the negative electrode first current collecting part 61.

As illustrated in FIG. 5, each of the positive electrode terminal 30 and the negative electrode terminal 40 is attached to the sealing plate 14. The positive electrode terminal 30 is disposed on one side (on the left side in FIG. 5) of the sealing plate 14 in the long side direction Y. The negative electrode terminal 40 is disposed on the other side (on the right side in FIG. 5) of the sealing plate 14 in the long side direction Y. Although the positive electrode terminal 30 side is described as the example in detail below, the negative electrode terminal 40 side can also have the similar structure.

As illustrated in FIG. 2, the positive electrode terminal 30 is electrically connected to the positive electrode 22 (specifically, the positive electrode tab group 23) of each of the electrode bodies 20a, 20b, and 20c through the positive electrode current collecting part 50 inside the case 10. The positive electrode terminal 30 is electrically connected to the positive electrode first current collecting part 51 of the positive electrode current collecting part 50 by the caulking process (mechanical fastening) and welding bonding. The positive electrode terminal 30 is preferably formed of a metal and is more preferably formed of, for example, aluminum or an aluminum alloy. The positive electrode terminal 30 is one example of the first member made of a metal disclosed herein.

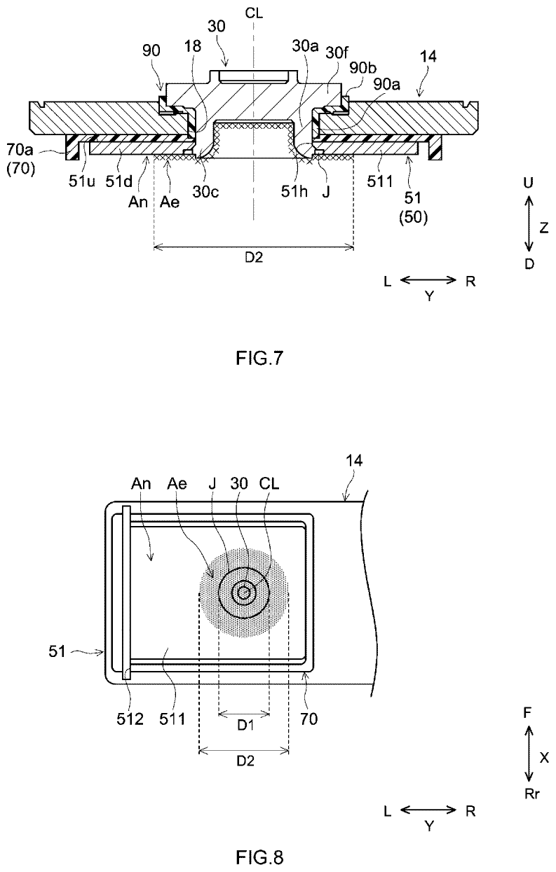

FIG. 7 is a cross-sectional view taken along line VII-VII in FIG. 5 and is a partially enlarged cross-sectional view schematically illustrating the positive electrode terminal 30 and its vicinity. Note that in FIG. 7, a center axis CL of the positive electrode terminal 30 is expressed by a dash-dotted line. As illustrated in FIG. 7, the positive electrode terminal 30 extends from the inside to the outside of the sealing plate 14 through the terminal extraction hole 18 of the sealing plate 14. The positive electrode terminal 30 includes the shaft part 30a, a flange part 30f with the diameter increasing from an upper end part of the shaft part 30a, and a caulking part 30c provided at a lower end part of the shaft part 30a.

As illustrated in FIG. 7, the shaft part 30a extends in the up-down direction Z along the center axis CL. The shaft part 30a is inserted to the terminal extraction hole 18 of the sealing plate 14 and a penetration hole 51h (see FIG. 6) of the positive electrode first current collecting part 51 to be described below. The shaft part 30a has a cylindrical shape here. The lower end part of the shaft part 30a, that is, an end part on the side opposite to the side where the flange part 30f exists is hollow.

The flange part 30f is coupled to the upper end part of the shaft part 30a and extends upward as illustrated in FIG. 7. The flange part 30f has a larger outer shape than the shaft part 30a. The flange part 30f has a larger outer shape than the terminal extraction hole 18 of the sealing plate 14. The flange part 30f protrudes out of the case 10 through the terminal extraction hole 18 (specifically, to an outer surface of the sealing plate 14). The flange part 30f has a circular shape here in a plan view. The outer shape of the flange part 30f is an approximately cylindrical columnar shape here. An axis center of the flange part 30f coincides with an axis center of the shaft part 30a.

As illustrated in FIG. 7, the caulking part 30c is provided at the end part (lower end part in FIG. 7) of the shaft part 30a inside the case 10. The caulking part 30c is provided at a periphery of the terminal extraction hole 18 of the sealing plate 14. The caulking part 30c is a part resulting from the spread of the lower end part of the shaft part 30a by the caulking process when the positive electrode terminal 30 is attached to the sealing plate 14. The caulking part 30c is preferably provided axis-symmetrically about the center axis CL of the positive electrode terminal 30. Thus, for example, even if vibration, impact, or the like is applied in the use of the electrical energy storage device 100, the electrical connection between the positive electrode terminal 30 and the positive electrode current collecting part 50 can be maintained stably and the conduction reliability of the positive electrode terminal 30 can be improved. The caulking part 30c has a ring-like shape (for example, annular shape) here in a plan view, and is provided along the entire periphery of the terminal extraction hole 18.

As illustrated in FIG. 7, the gasket 90 is an insulating member that is disposed between the sealing plate 14 and the positive electrode terminal 30. The gasket 90 has functions of insulating between the sealing plate 14 and the positive electrode terminal 30 and closing the terminal extraction hole 18 here. The gasket 90 has an electrical insulating property and is formed of a resin material capable of elastic deformation, for example fluororesin such as perfluoro alkoxy fluorine resin (PFA), polyphenylene sulfide resin (PPS), aliphatic polyamide, or the like. The gasket 90 includes a tubular part 90a and a base part 90b here.

The tubular part 90a is a part that prevents direct contact between the sealing plate 14 and the shaft part 30a of the positive electrode terminal 30. The tubular part 90a has a hollow cylindrical shape. The tubular part 90a includes a penetration hole penetrating in the up-down direction Z at a position corresponding to the terminal extraction hole 18 of the sealing plate 14. The penetration hole has an inner diameter that enables penetration of the shaft part 30a of the positive electrode terminal 30 before the caulking process. The tubular part 90a is inserted to the terminal extraction hole 18 of the sealing plate 14. The base part 90b is a part that prevents direct contact between the sealing plate 14 and the flange part 30f of the positive electrode terminal 30. The base part 90b is coupled to an upper end of the tubular part 90a. The base part 90b is provided in an annular shape so as to surround the terminal extraction hole 18 of the sealing plate 14 here. The base part 90b is held between a lower surface of the flange part 30f of the positive electrode terminal 30 and the sealing plate 14, and compressed in the up-down direction Z by the caulking process.

The positive electrode current collecting part 50 constitutes a conductive path that electrically connects the positive electrode tab group 23 (positive electrode 22) constituted by the plurality of positive electrode tabs 22t, and the positive electrode terminal 30 as illustrated in FIG. 2. The positive electrode current collecting part 50 may be formed of the same metal species as the positive electrode current collector 22c, for example, a conductive metal such as aluminum, an aluminum alloy, nickel, or stainless steel. The positive electrode current collecting part 50 is preferably formed of aluminum or an aluminum alloy. The positive electrode current collecting part 50 includes the positive electrode first current collecting part 51 extending along the inner surface of the sealing plate 14 (see also FIG. 6) and the positive electrode second current collecting part 52 extending along the short side wall 12c of the case main body 12 (see also FIG. 3) here.

The positive electrode first current collecting part 51 is fixed to the sealing plate 14 by the caulking part 30c and a welding bonding part J as illustrated in FIG. 7. The positive electrode first current collecting part 51 has an approximately L-like shape as illustrated in FIG. 6. The positive electrode first current collecting part 51 may be configured by bending one member by, for example, a pressing process or the like, or may be configured by integrating a plurality of members by welding bonding or the like. The positive electrode first current collecting part 51 includes a first part 511 that spreads horizontally along the inner surface of the sealing plate 14, and a second part 512 that extends along the up-down direction Z from an end of the first part 511 on one side in the long side direction Y (the left end in FIG. 6). The positive electrode first current collecting part 51 is one example of the second member made of a metal disclosed herein.

As illustrated in FIG. 7, the first part 511 is a part that is electrically connected to the positive electrode terminal 30 by the caulking part 30c and the welding bonding part J. The first part 511 has a flat-plate shape. Although not limited in particular, a thickness T of the first part 511 is typically 0.5 to 5 mm, for example 1 to 3 mm, and about 1.5 to 2 mm. The first part 511 includes an upper surface 51u and a lower surface 51d. The resin member 70 is disposed between the sealing plate 14 and the upper surface 51u of the first part 511. The first part 511 is insulated from the sealing plate 14 by the resin member 70. In the first part 511, the penetration hole 51h penetrating in the up-down direction Z is formed at a position corresponding to the terminal extraction hole 18 of the sealing plate 14. To the penetration hole 51h, the positive electrode terminal 30 (specifically, shaft part 30a) is inserted as illustrated in FIG. 6.

As illustrated in FIG. 7, the welding bonding part J that is formed by laser welding is provided at a boundary portion between a peripheral part of the penetration hole 51h of the first part 511 and the caulking part 30c of the positive electrode terminal 30. By the provision of the welding bonding part J, the electrical connection between the positive electrode terminal 30 and the positive electrode current collecting part 50 can be stably maintained and the conduction reliability can be improved. The welding bonding part J is formed by a laser welding step (step S4) to be described below. The welding bonding part J is one example of a welding bonding part between the first member and the second member disclosed herein.

The welding bonding part J is provided around the center axis CL of the positive electrode terminal 30. The welding bonding part J is preferably provided axis-symmetrically about the center axis CL of the positive electrode terminal 30. Thus, for example, even if vibration, impact, or the like is applied in the use of the electrical energy storage device 100, the electrical connection between the positive electrode terminal 30 and the positive electrode current collecting part 50 can be maintained stably and the conduction reliability of the positive electrode terminal 30 can be improved. The welding depth of the welding bonding part J (the maximum length in the up-down direction Z, the vertical length from the lower surface 51d of the first part 511 to the end part of the welding bonding part J on the upper surface 51u side) is typically 0.15 mm or more, for example 0.15 to 0.5 mm, or about 0.3 to 0.4 mm.

FIG. 8 is a partially enlarged plan view schematically illustrating the welding bonding part J in FIG. 6 and its vicinity, and similarly to FIG. 6, depicts a surface (inner surface) of the sealing plate 14 on the case main body 12 side. In the plan view, it is preferable that the welding bonding part J be provided to have a ring shape (for example, annular shape), a U-like shape, a C-like shape (semi-circular shape), or the like along the caulking part 30c and particularly preferable that the welding bonding part J be provided to have a ring shape (for example, annular shape) as illustrated in FIG. 8. That is to say, it is particularly preferable that the welding bonding part J be provided continuously at the entire periphery of the penetration hole 51h (see FIG. 7). A diameter D1 of the welding bonding part J with a ring shape (for example, annular shape) is, for example, about 10 mm.

As illustrated in FIG. 7 and FIG. 8, a roughened part Ae is provided at a surface of the welding bonding part J and its peripheral part. Note that the term “peripheral part” of the welding bonding part J described herein refers to, for example, a region where weld spatter can scatter in the laser welding step (step S4) to be described below. Therefore, although the peripheral part is not limited in particular because it can differ depending on conditions of the laser welding and the like, the peripheral part refers to the range within about 5 mm from the welding bonding part J. The roughened part Ae is a region irradiated with an energy beam in an etching step (step S5) to be described below. Note that a region around the roughened part Ae (that is, a region not irradiated with the energy beam in the etching step (step S5)) is also referred to as a general part An below.

As illustrated in FIG. 7, in the cross-sectional view, the roughened part Ae is formed axis-symmetrically about the center axis CL of the positive electrode terminal 30 here. As illustrated in FIG. 8, in the plan view, the roughened part Ae has a substantially circular shape (specifically, perfect circular shape) with the center axis CL of the positive electrode terminal 30 as a center here. A diameter D2 of the roughened part Ae is larger than the diameter D1 of the welding bonding part J, and is preferably about 1 to 20 mm, for example about 10 mm, larger than the diameter D1. The diameter D2 of the roughened part Ae is about 20 mm here. Although the roughened part Ae has a perfect circular shape here, other shapes, for example, an elliptical shape and a polygonal shape such as a square may be employed.

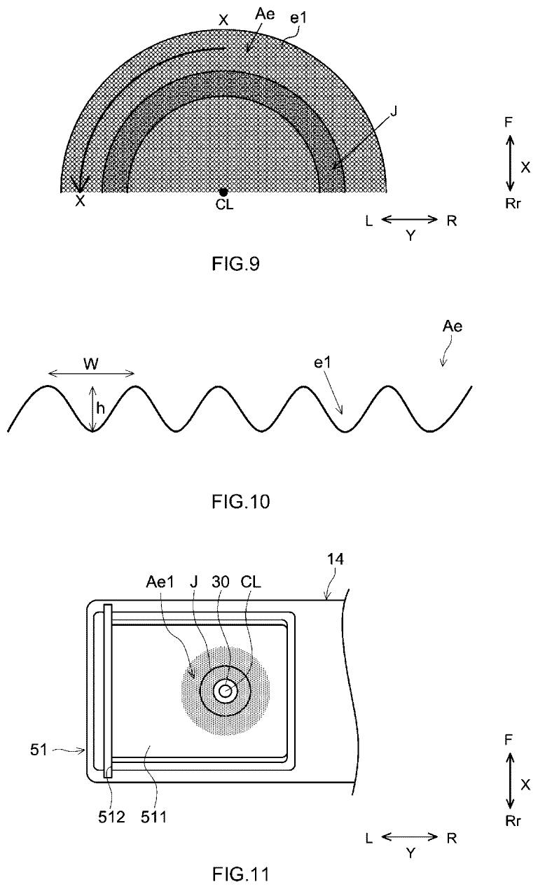

FIG. 9 is a partially enlarged view of a front half of the roughened part Ae in FIG. 8. As illustrated in FIG. 9, the roughened part Ae has a plurality of concave parts e1 with a substantially circular shape. Thus, the roughened part Ae is more concavo-convex than its periphery (for example, a region more apart than the roughened part Ae from the center axis CL of the positive electrode terminal 30, the general part An in FIG. 8). The plurality of concave parts e1 can be formed by, for example, being irradiated with an energy beam intermittently using a pulsed-oscillation laser or the like in the etching step (step S5) to be described below. Note that “the substantially circular shape” is a term that is distinguished from a linear shape (band-like shape) and encompasses a circular shape and an elliptical shape whose aspect ratio is about 1:5 to 5:1, preferably 1:2 to 2:1.

The plurality of concave parts e1 are preferably arranged regularly. In this embodiment, as illustrated in FIG. 8, the roughened part Ae has a substantially circular shape in a plan view and as illustrated in FIG. 9, the plurality of concave parts e1 are arranged in a circumferential direction (arc-like shape). The plurality of concave parts e1 are disposed uniformly with the center axis CL of the positive electrode terminal 30 as a center. In another embodiment, however, the plurality of concave parts e1 may be disposed linearly or in another form.

FIG. 10 is a cross-sectional view taken along line X-X in FIG. 9. As illustrated in FIG. 10, the plurality of concave parts e1 are arranged regularly at an optional arc-shaped cross section along the circumferential direction in the roughened part Ae. Accordingly, the cross section of the roughened part Ae has a concavo-convex shape and is more concavo-convex than its periphery (general part An). In some embodiments, a diameter w of the concave part e1 (the average diameter, spot diameter, of the plurality of concave parts e1) is preferably 5 to 200 μm, more preferably 10 to 150 μm, and still more preferably 20 to 100 μm. Note that the diameter w of the concave part e1 mainly depends on the specification of a device used in the etching step (step S5) to be described below and can be adjusted by, for example, the amount of heat, output, irradiation time, and the like of the energy beam such as laser.

In some embodiments, a depth h of the concave part e1 (the average of the maximum depths of the plurality of concave parts e1) is preferably 0.1 μm or more, more preferably 0.5 μm or more, and still more preferably 1 μm or more. Note that the depth h of the concave part e1 can be formed by mainly adjusting the output and the amount of heat of the energy beam such as laser in the etching step (step S5) to be described below. By the irradiation with the energy beam so that the concave part e1 has the depth h that is a predetermined value or more in the etching step, which will be described in detail in the paragraph about the manufacturing method, the effect of the art disclosed herein can be achieved at the high level. The depth h of the concave part e1 is generally smaller than the welding depth of the welding bonding part J, and is preferably 50 μm or less, more preferably 20 μm or less, and still more preferably 10 μm or less. By the irradiation with the energy beam so that the concave part e1 has the depth h that is a predetermined value or less in the etching step, which will be described in detail in the paragraph about the manufacturing method, the occurrence of another weld spatter can be suppressed more. In addition, the bonding strength of the welding bonding part J can be improved.

As illustrated in FIG. 2, the positive electrode second current collecting part 52 extends along the short side wall 12c of the case main body 12. One end part of the positive electrode second current collecting part 52 (upper end part in FIG. 2) is electrically connected to the positive electrode first current collecting part 51 (specifically, second part 512 (see FIG. 6)). The other end part of the positive electrode second current collecting part 52 (lower end part in FIG. 2) is attached to the positive electrode tab group 23 and electrically connected to the plurality of positive electrode tabs 22t. The positive electrode second current collecting part 52 and the positive electrode tab group 23 are, for example, bonded by welding in a state where the plurality of positive electrode tabs 22t are overlapped on each other.

As illustrated in FIG. 7, the resin member 70 is an insulating member that is disposed between a lower surface (inner surface) of the sealing plate 14 and the first part 511 of the positive electrode first current collecting part 51. The resin member 70 has the resistance against the nonaqueous electrolyte solution to be used and the electrical insulating property, and is formed of a resin material capable of elastic deformation, for example, fluororesin such as perfluoro alkoxy fluorine resin (PFA), polyphenylene sulfide resin (PPS), or the like. As illustrated in FIG. 7 and FIG. 8, the resin member 70 includes a base part 70a that extends horizontally along an inner surface of the sealing plate 14. As illustrated in FIG. 7, the base part 70a is a part that prevents direct contact between the sealing plate 14 and the positive electrode first current collecting part 51. The base part 70a includes a penetration hole penetrating in the up-down direction Z at a position corresponding to the terminal extraction hole 18 of the sealing plate 14. To the penetration hole, the shaft part 30a of the positive electrode terminal 30 and the tubular part 90a of the gasket 90 are inserted.

As illustrated in FIG. 2, the negative electrode terminal 40 is electrically connected to the negative electrode 24 (specifically, the negative electrode tab group 25) of each of the electrode bodies 20a, 20b, and 20c through the negative electrode current collecting part 60 inside the case 10. The structure of the negative electrode terminal 40 may be similar to or different from that of the aforementioned positive electrode terminal 30. The negative electrode terminal 40 is electrically connected to the negative electrode first current collecting part 61 of the negative electrode current collecting part 60 by the caulking process (mechanical fastening) and welding bonding in a manner similar to the positive electrode terminal 30 here. The negative electrode terminal 40 extends from the inside to the outside of the sealing plate 14 through the terminal extraction hole 19 of the sealing plate 14. The negative electrode terminal 40 is provided symmetrically to the positive electrode terminal 30 and includes a flange part (reference sign is omitted), a shaft part 40a, and a caulking part 40c here.

The negative electrode terminal 40 is preferably made of a metal such as copper or a copper alloy. The negative electrode terminal 40 may be configured of two conductive members bonded together and integrated. In the negative electrode terminal 40, for example, the caulking part 40c or the shaft part 40a to be connected to the negative electrode current collecting part 60 may be formed of copper or a copper alloy, and the flange part protruding out of the case 10 (specifically, to the outer surface of the sealing plate 14) through the terminal extraction hole 19 may be formed of aluminum or an aluminum alloy. The negative electrode terminal 40 is one example of the first member made of a metal disclosed herein.

The negative electrode current collecting part 60 constitutes a conductive path that electrically connects the negative electrode tab group 25 (negative electrode 24) constituted by the plurality of negative electrode tabs 24t and the negative electrode terminal 40 as illustrated in FIG. 2. The negative electrode current collecting part 60 may be formed of the same metal species as the negative electrode current collector 24c, for example, a conductive metal such as copper, a copper alloy, nickel, or stainless steel. The negative electrode current collecting part 60 here includes the negative electrode first current collecting part 61 and the negative electrode second current collecting part 62. Structures of the negative electrode first current collecting part 61 and the negative electrode second current collecting part 62 may be equal to the structures of the positive electrode first current collecting part 51 and the positive electrode second current collecting part 52 of the positive electrode current collecting part 50, respectively. The negative electrode first current collecting part 61 is one example of the second member made of a metal disclosed herein.

As illustrated in FIG. 6, the negative electrode first current collecting part 61 is bonded by welding to the caulking part 40c of the negative electrode terminal 40. At a boundary portion between the negative electrode first current collecting part 61 and the caulking part 40c, the welding bonding part J formed by laser welding is provided similarly to the positive electrode side. At the surface of the welding bonding part J and its peripheral part, the roughened part Ae is provided similarly to the positive electrode side.

### <Manufacturing Method for Sealing Plate Assembly>

The sealing plate assembly illustrated in FIG. 5 and FIG. 6 can be manufactured by fixing the positive electrode terminal 30, the positive electrode current collecting part 50 (specifically, positive electrode first current collecting part 51), the negative electrode terminal 40, and the negative electrode current collecting part 60 (specifically, negative electrode first current collecting part 61) to the sealing plate 14 in a state of being insulated from the sealing plate 14. Although not limited in particular, the sealing plate assembly can be manufactured by a manufacturing method including, for example, an assembling step (step S1) for the members, a caulking step (step S2) of forming the caulking part at one end part of the shaft part of the terminal, a cover disposing step (step S3) of disposing a cover in a non-welding part excluding the boundary portion between the caulking part and the current collecting part, the laser welding step (step S4) of forming the welding bonding part at the boundary portion between the caulking part and the current collecting part, and the etching step (step S5) of irradiating the surface of the welding bonding part and its peripheral part with the energy beam. The laser welding step (step S4) and the etching step (S5) are one example of the bonding method disclosed herein.

Note that the caulking step (step S2) and the cover disposing step (step S3) are optional and can be omitted in another embodiment. Although the positive electrode side will be described in detail below, the negative electrode side may be similar to the positive electrode side. In this case, “positive electrode” can be replaced by “negative electrode” as appropriate. The manufacturing method disclosed herein may further include another step at an optional stage.

In the assembling step (step S1), the positive electrode terminal 30, the positive electrode current collecting part 50, the negative electrode terminal 40, and the negative electrode current collecting part 60 are assembled to the sealing plate 14 typically in a state of being insulated from the sealing plate 14. As illustrated in FIG. 7, the positive electrode terminal 30 and the positive electrode current collecting part 50 are assembled in such a way that, for example, the flange part 30f of the positive electrode terminal 30 is disposed on the outer surface of the sealing plate 14 with the gasket 90 interposed therebetween and the positive electrode current collecting part 50 is disposed on the inner surface of the sealing plate 14 with the resin member 70 interposed therebetween. Specifically, the respective members are assembled in such a way that the shaft part 30a of the positive electrode terminal 30 before the caulking process is inserted sequentially to the tubular part 90a of the gasket 90, the terminal extraction hole 18 of the sealing plate 14, the penetration hole of the resin member 70, and the penetration hole 51h of the first part 511 of the positive electrode current collecting part 50 so as to protrude downward relative to the lower surface 51d of the penetration hole 51h. Note that the negative electrode terminal 40 and the negative electrode current collecting part 60 are assembled to the sealing plate 14 similarly.

In the caulking step (step S2), the caulking part 30c is formed by deforming one end of the shaft part 30a of the positive electrode terminal 30 assembled to the sealing plate 14 by the caulking process (riveting) as illustrated in FIG. 7. Specifically, for example, the lower surface 51d of the first part 511 is placed on a fixed die, and a compression force in the up-down direction Z is applied to the shaft part 30a from above the flange part 30f of the positive electrode terminal 30 using a compression punch. Then, a tip end part of the shaft part 30a that protrudes downward relative to the lower surface 51d of the first part 511 is pressed against an inner surface of the penetration hole 51h of the positive electrode current collecting part 50. Thus, the tip end part of the shaft part 30a spreads and accordingly, the caulking part 30c is formed. Through such a caulking process, the positive electrode terminal 30 and the positive electrode current collecting part 50 are fixed to the sealing plate 14 and the terminal extraction hole 18 is sealed. The caulking part 40c can be similarly formed in the negative electrode terminal 40 and the negative electrode terminal 40 and the negative electrode current collecting part 60 can be fixed to the sealing plate 14.

In the cover disposing step (step S3), at least a partial region excluding the part where the welding bonding part J is formed is covered with the cover before the laser welding step (step S4). Thus, the region where the weld spatter can scatter in the laser welding step to be described below becomes narrow. Therefore, the region to be processed in the etching step (step S5) to be described below becomes narrower and the time required for the etching step can be shortened. The cover is made of, for example, resin. The cover is preferably about 5 mm apart from the part where the welding bonding part J is formed in order to prevent scorch in the laser welding step. In one example, the general part An in the positive electrode first current collecting part 51 may be entirely covered except the range where the roughened part Ae in FIG. 8 is formed (the range with a diameter of D2 with the center axis CL of the positive electrode terminal 30 as the center), for example.

In the laser welding step (step S4), the boundary portion between the positive electrode terminal 30 (the first member made of a metal) and the positive electrode first current collecting part 51 (the second member made of a metal) is irradiated with the laser to form the welding bonding part. Here, a boundary portion between the caulking part 30c provided at the tip end part of the shaft part 30a of the positive electrode terminal 30 and the periphery of the penetration hole 51h of the first part 511 of the positive electrode current collecting part 50 is irradiated with the laser. Thus, the welding bonding part J is formed at the boundary portion between the positive electrode terminal 30 and the positive electrode current collecting part 50. The laser irradiation can be performed similarly to the conventional method using a known laser welding device. The laser irradiation is preferably performed along a fitting line of the caulking part 30c. The welding bonding part J is preferably formed along the entire periphery (in a ring shape) of the penetration hole 51h. Note that by welding the caulking part 40c similarly to the periphery of the penetration hole of the negative electrode current collecting part 60, the welding bonding part J can also be formed at the boundary portion between the negative electrode terminal 40 and the negative electrode current collecting part 60.

The laser welding conditions are preferably changed on the positive electrode side and on the negative electrode side where the kind of metal is different. Although not limited in particular, the laser welding is preferably performed under the following conditions shown in Table 1 in some embodiments. For example, the welding bonding part J with the aforementioned welding depth can be formed suitably by increasing the output of the laser to 1000 W or more or 2000 W or more, or by increasing the amount of heat of the laser to 100 J or more or 200 J or more. Furthermore, by using a continuous-oscillation laser, linear welding becomes possible and the bonding strength can be improved.

TABLE 1
Example of laser welding conditions

| | | | | Irradi- | |
|---|---|---|---|---|---|
| | | | Scanning | ation | Amount of heat |
| | Oscillation | Output | speed | time | (J) Output × |
| | method | (W) | (mm/s) | (sec) | Irradiation time |
| Positive | Continuous | 3300 | 450 | 0.077 | 256 |
| electrode | | | | | |
| side | | | | | |
| Negative | Continuous | 2750 | 400 | 0.090 | 246 |
| electrode | | | | | |
| side | | | | | |

At the time of the laser welding, molten metal with high temperature may be generated from the welded part as microparticles (so-called weld spatter). Therefore, after the laser welding, the weld spatter may scatter randomly at the surface of the welding bonding part J and its peripheral part.

In the etching step (step S5), the surface of the welding bonding part J and its peripheral part are irradiated with the energy beam with lower output than that in the laser welding step (step S4). Thus, the welding spatter that has scattered randomly at the surface of the welding bonding part J and its peripheral part can be melted again and removed. The energy beam is preferably laser or an electron beam, and more preferably laser. In this step, a device with low output, such as a laser marker, can be used suitably. Note that the laser welding device that is employed in the laser welding step (step S4) can also be used as long as the output can be adjusted. The irradiation with the energy beam in this step is preferably performed intermittently and regularly using the pulsed-oscillation laser. Thus, the weld spatter can be suitably removed easily with the relatively easy device setting. In another embodiment, however, other energy beam than the pulsed-oscillation laser, such as an electron beam or continuous-oscillation laser, can be used to perform the pulsed irradiation by changing the output in the pulsed way.

The scanning with the energy beam is preferably performed along the welding bonding part J. Here, since the welding bonding part J has an annular shape and has a curved part, the scanning with the energy beam is preferably performed along the circumferential direction of the welding bonding part J (arc-like shape). Thus, the plurality of concave parts e1 are formed along the circumferential direction. However, the scanning with the energy beam may be performed linearly or spirally, for example.

In this step, the output of the energy beam (preferably, the laser output) is made lower than the output of the laser in the laser welding step (step S4). This makes it possible to suppress the occurrence of another weld spatter in this step. From such a viewpoint, according to the present inventor's examination, the output of the energy beam in this step is preferably about 200 W or less, more preferably 100 W or less, still more preferably 50 W or less, and particularly preferably 30 W or less. In addition, the output of the energy beam in this step is preferably about 5 W or more, and more preferably 10 W or more. This makes it easy to remove even the relatively large weld spatter in a short time.

In some embodiments, when the output of the laser in the laser welding step (step S4) is 100, the output ratio of the energy beam in this step is preferably 0.1 or more, more preferably 0.2 or more, and still more preferably 0.5 or more, for example. This makes it easy to remove efficiently the weld spatter generated in the laser welding step (step S4) in a shorter time. In addition, it becomes easier to form the concave part e1 with the aforementioned depth h (for example, 1 to 10 μm) suitably. The output ratio is preferably about 3 or less, more preferably 2 or less, and still more preferably 1 or less, for example. This makes it possible to suppress the occurrence of another weld spatter in this step.

The scanning speed of the energy beam in this step is preferably higher than that in the laser welding step (step S4). Thus, the productivity and the work efficiency can be improved. Furthermore, the occurrence of another weld spatter can be suppressed more. Although not limited in particular, the scanning speed in this step is preferably 1000 mm/s or more, more preferably 2000 mm/s or more, and still more preferably 3000 mm/s or more. In addition, the scanning speed in this step is preferably about 12000 mm/s or less, more preferably 10000 mm/s or less, and still more preferably 5000 mm/s or less. This makes it easy to remove even the relatively large weld spatter.

In the case of using the pulsed-oscillation laser, the pulse frequency of the laser in this step is to adjust the intervals of the plurality of concave parts e1, and is preferably determined based on the diameter w of the concave part e1, the scanning speed, or the like. Although not limited in particular, the pulse frequency of the laser in this step is preferably 10000 to 100000 and more preferably 30000 to 80000. This makes it easy to suitably remove the weld spatter that has scattered randomly.

Since the amount of heat of the energy beam is expressed by output×irradiation time, the amount of heat of the energy beam in this step is preferably lower than that in the laser welding step (step S4) typically. This makes it possible to suppress the occurrence of another weld spatter in this step further. From such a viewpoint, the amount of heat of the energy beam in this step is preferably about 0.01 J or less, more preferably 0.001 J or less, and still more preferably 0.0005 J or less. The amount of heat of the energy beam in this step is preferably about 0.00001 J or more and more preferably 0.0001 J or more. This makes it easy to remove even the relatively large weld spatter in a short time.

In some embodiments, when the amount of heat of the laser in the laser welding step (step S4) is 100, the ratio of the amount of heat of the energy beam in this step is preferably about 0.01 or less, more preferably 0.001 or less, and still more preferably 0.0005 or less, for example. This makes it easy to remove the weld spatter generated in the laser welding step (step S4) efficiently in a shorter time. In addition, it becomes easier to form the concave part e1 with the aforementioned depth h (for example, 1 to 10 μm) suitably.

Although not limited in particular, in some embodiments, the etching can be performed using the laser under the conditions as shown in Table 2 below.

TABLE 2
Example of etching conditions

| | | | Irradiation | | |
|---|---|---|---|---|---|
| | | Scanning | time (sec) | Pulse | Amount of heat |
| Oscillation | Output | speed | 1/pulse | frequency | (J) Output × |
| method | (W) | (mm/s) | frequency | (kHz) | Irradiation time |
| Pulsed | 25 | 3600 | 0.00002 | 60 | 0.0004 |

In this step, the plurality of concave parts e1 with the substantially circular shape are formed at the surface of the welding bonding part J and its peripheral part in this manner. That is to say, the roughened part Ae is formed. As described above, in the art disclosed herein, by irradiating the surface of the welding bonding part and its peripheral part with the energy beam (preferably laser) in the etching step, the weld spatter that has scattered to the random positions in the laser welding step can be efficiently removed. As a result, the remaining of the weld spatter can be reduced suitably. Accordingly, the electrical energy storage device 100 with high reliability can be provided.

Other methods of removing the weld spatter include a method of removing the weld spatter manually by checking the weld spatter with human eyes, a method of detecting the position of the weld spatter with a camera and irradiating the weld spatter with the energy beam with pinpoint accuracy, and the like. However, the removal by humans costs high. In addition, the weld spatter may be missed by a human error. On the other hand, the method of irradiating the weld spatter with the energy beam with the pinpoint accuracy has disadvantages that purchasing the camera costs high and reading with the camera and irradiating with the energy beam take long tact time. The art disclosed herein can be said to be the method of being able to remove the weld spatter efficiently and suitably with the relatively low cost compared to those methods.

### <Manufacturing Method for Electrical Energy Storage Device>

The electrical energy storage device 100 can be manufactured by, for example, a manufacturing method including preparing the sealing plate assembly, the electrode body group 20, the nonaqueous electrolyte solution, and the case main body 12 as described above, and the manufacturing method further includes an attaching step and a constructing step.

In the attaching step, the electrode body group 20 is attached to the sealing plate 14 to manufacture a united object (sealing plate assembly) of the sealing plate 14 and the electrode body group 20 as illustrated in FIG. 3. Specifically, the positive electrode second current collecting part 52 is attached to the positive electrode tab group 23 of each of the electrode bodies 20a, 20b, and 20c and the positive electrode second current collecting part 52 is bonded (for example, bonded by welding) to the positive electrode first current collecting part 51 of the sealing plate assembly. Thus, the positive electrode 22 of each of the electrode bodies 20a, 20b, and 20c is electrically connected to the positive electrode terminal 30. Similarly, the negative electrode second current collecting part 62 is attached to the negative electrode tab group 25 of each of the electrode bodies 20a, 20b, and 20c and the negative electrode second current collecting part 62 is bonded (for example, bonded by welding) to the negative electrode first current collecting part 61 of the sealing plate assembly. Thus, the negative electrode 24 of each of the electrode bodies 20a, 20b, and 20c is electrically connected to the negative electrode terminal 40. Thus, the sealing plate assembly and the electrode body group 20 are integrated.

As illustrated in FIG. 1 and FIG. 2, in the constructing step, the electrode body group 20 integrated with the sealing plate 14 is accommodated in the internal space of the case main body 12 and the case main body 12 and the sealing plate 14 are sealed. The sealing can be performed by, for example, welding such as laser welding. After that, the nonaqueous electrolyte solution is injected through the liquid injection hole 15 of the sealing plate 14 and by covering the liquid injection hole 15 with the sealing member 16, the electrical energy storage device 100 is sealed. In this manner, the electrical energy storage device 100 can be manufactured.

### <Application of Electrical Energy Storage Device>

The electrical energy storage device 100 can also be suitably used as a battery pack in which the plurality of electrical energy storage devices 100 are electrically connected to each other through a busbar. In this case, for example, the plurality of electrical energy storage devices 100 can be electrically connected to each other by disposing the conductive member such as a busbar between the positive electrode terminal 30 and the negative electrode terminal 40 of the adjacent electrical energy storage devices 100. The electrical energy storage device 100 can be used in various applications, and suitably used as, for example, a motive power source (electrical power source for driving) for a motor mounted on a vehicle such as a passenger car or a truck. Although the type of vehicles is not particularly limited, examples thereof may include a plug-in hybrid electric vehicle (PHEV), a hybrid electric vehicle (HEV), a battery electric vehicle (BEV), and the like.

Although some embodiments of the present disclosure have been described above, the above-described embodiments are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed. For example, another modification can replace a part of the aforementioned embodiment or be added to the aforementioned embodiment. Additionally, the technical feature may be deleted as appropriate unless such a feature is described as an essential element.

### <First Modification>

In the aforementioned embodiment, for example, the cover is disposed except the range with the diameter of D2 with the center axis CL of the positive electrode terminal 30 as the center in the cover disposing step (step S3) and the roughened part Ae (see FIG. 8) with the substantially circular shape in the plan view is formed in the etching step (step S5). However, the present disclosure is not limited to this example. In another example, a bottom surface of the positive electrode terminal 30 (an inner peripheral side of the caulking part 30c with the annular shape) is depressed into the concave shape as illustrated in FIG. 7. Therefore, in some cases, the irradiation with the energy beam is difficult in the etching step. In those cases, it is preferable to dispose the cover also in the part of the positive electrode terminal 30 that is depressed into the concave shape in the cover disposing step (step S3).

In the cover disposing step (step S3), as long as the cover is provided in the part of the positive electrode terminal 30 that is depressed into the concave shape, the weld spatter will not scatter to that part in the laser welding step (step S4). Therefore, in the etching step (step S5), it is no longer necessary to irradiate that part with the energy beam and the time required for the etching step can be shortened. FIG. 11 is a diagram corresponding to FIG. 8 according to this modification. As illustrated in FIG. 11, a roughened part Ae1 with an annular shape (donut shape) in a plan view is formed at the surface of the welding bonding part J and its peripheral part in the etching step in this modification.

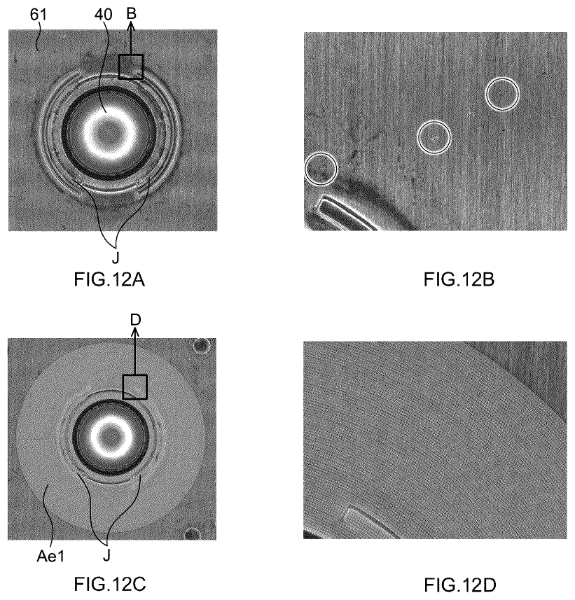

Example on the negative electrode side according to this modification is illustrated in FIGS. 12A to 12D. In this Example, both the negative electrode terminal 40 as the first member and the negative electrode first current collecting part 61 as the second member are made of copper (C1020). FIG. 12A is an observation image of the welding bonding part J and its vicinity before the etching step (step S5) and FIG. 12B is a partially enlarged view of FIG. 12A. As expressed in FIG. 12A, there are two welding bonding parts J here, each of which is provided in a C-like shape. As indicated by circular marks in FIG. 12B, it is recognized that the weld spatter scatters randomly near the welding bonding parts J.

In view of this, in this Example, the etching step was performed using the following device. The etching conditions by the laser are as shown above in Table 2.
Device: 3-Axis hybrid laser marker manufactured by KEYENCE CORPORATION (model type: MD-X2500A)
Laser wavelength: 1064 nm (IR)
Laser power: 90%
Kind of solid line: contour
Intervals of solid lines: 0.06 mm

FIG. 12C is an observation image of the welding bonding part J and its vicinity after the etching step (step S5) and FIG. 12D is a partially enlarged view of FIG. 12C. As expressed in FIG. 12C, it is recognized that the plurality of concave parts with the substantially circular shape are formed at the surface of the welding bonding part J and its peripheral part, and the roughened part Ae1 with the annular shape is formed. In addition, as illustrated in FIG. 12D, it is understood that the weld spatter that used to exist before the etching step is absent after the etching step.

### <Second Modification>

For example, in the embodiment described above, the first member is the terminal (positive electrode terminal 30 or negative electrode terminal 40) and the second member is the current collecting part (positive electrode first current collecting part 51 or negative electrode first current collecting part 61). However, the present disclosure is not limited to this example. In another example, the first member may be the terminal (positive electrode terminal 30 or negative electrode terminal 40) and the second member may be the conductive member such as a bus bar in the battery pack described above.

As described above, the following items are given as specific aspects of the art disclosed herein.

Item 1: The bonding method including: the laser welding step of irradiating the boundary portion between the first member made of a metal and the second member made of a metal with the laser, thereby forming the welding bonding part; and the etching step of irradiating the surface of the welding bonding part and its peripheral part with the energy beam with lower output than the output in the laser welding step, thereby forming the plurality of concave parts with the substantially circular shape at the surface of the welding bonding part and its peripheral part.
Item 2: The bonding method according to Item 1, in which the energy beam has an output of 50 W or less in the etching step.
Item 3: The bonding method according to Item 1 or 2, in which the scanning speed of the energy beam in the etching step is higher than the scanning speed in the laser welding step.
Item 4: The bonding method according to any one of Items 1 to 3, in which the plurality of concave parts with a diameter of 20 to 100 μm and a depth of 1 to 10 μm are formed in the etching step.
Item 5: The bonding method according to any one of Items 1 to 4, in which the plurality of concave parts are formed regularly in the etching step.
Item 6: The bonding method according to any one of Items 1 to 5, in which the scanning with the energy beam is performed along the welding bonding part in the etching step.
Item 7: The bonding method according to any one of Items 1 to 6, in which the scanning with the energy beam is performed along the circumferential direction of the welding bonding part having the curved part in the etching step, thereby forming the plurality of concave parts that are arranged in the circumferential direction.
Item 8: The bonding method according to any one of Items 1 to 7, further including the cover disposing step of covering at least the partial region excluding the part where the welding bonding part is formed, with the cover before the laser welding step, in which the region not covered with the cover is irradiated with the energy beam in the etching step.
Item 9: The manufacturing method for an electrical energy storage device, including the bonding method according to any one of Items 1 to 8, in which the electrical energy storage device includes the first member and the second member as the constituent elements.
Item 10: The electrical energy storage device including the first member made of a metal, the second member made of a metal, the welding bonding part of the first member and the second member, and the roughened part provided at the surface of the welding bonding part and its peripheral part, in which the roughened part includes the plurality of concave parts with the substantially circular shape and is more concavo-convex than its periphery.
Item 11: The electrical energy storage device according to Item 10, in which the concave part has a diameter of 20 to 100 μm and a depth of 1 to 10 μm.
Item 12: The electrical energy storage device according to Item 10 or 11, in which the plurality of concave parts are disposed regularly.
Item 13: The electrical energy storage device according to any one of Items 10 to 12, in which the roughened part is provided in the substantially circular shape or the annular shape in the plan view, and the plurality of concave parts are arranged in the circumferential direction.
Item 14: The electrical energy storage device according to any one of Items 10 to 13, including: the electrode body including the first electrode and the second electrode; the case that accommodates the electrode body; the terminal electrically connected to the first electrode and attached to the case; and the current collecting part that is disposed in the case and electrically connects the first electrode and the terminal, in which the first member is the terminal, and the second member is the current collecting part.

### REFERENCE SIGNS LIST

10 Case
20a, 20b, 20c Electrode body
22 Positive electrode (first electrode)
24 Negative electrode (second electrode)
30 Positive electrode terminal (terminal)
30c Caulking part
40 Negative electrode terminal (terminal)
50 Positive electrode current collecting part
51 Positive electrode first current collecting part (current collecting part)
60 Negative electrode current collecting part
61 Negative electrode first current collecting part (current collecting part)
100 Electrical energy storage device
J Welding bonding part
Ae Roughened part
e1 Concave part
An General part

What is claimed is:

1. A bonding method comprising:
a laser welding step of irradiating a boundary portion between a first member made of a metal and a second member made of a metal with laser, thereby forming a welding bonding part; and
an etching step of irradiating a surface of the welding bonding part and its peripheral part with an energy beam with lower output than an output in the laser welding step, thereby forming a plurality of concave parts with a substantially circular shape at the surface of the welding bonding part and its peripheral part.

2. The bonding method according to claim 1, wherein the energy beam has an output of 50 W or less in the etching step.

3. The bonding method according to claim 1, wherein a scanning speed of the energy beam in the etching step is higher than the scanning speed in the laser welding step.

4. The bonding method according to claim 1, wherein the plurality of concave parts with a diameter of 20 to 100 μm and a depth of 1 to 10 μm are formed in the etching step.

5. The bonding method according to claim 1, wherein the plurality of concave parts are formed regularly in the etching step.

6. The bonding method according to claim 1, wherein scanning with the energy beam is performed along the welding bonding part in the etching step.

7. The bonding method according to claim 1, wherein scanning with the energy beam is performed along a circumferential direction of the welding bonding part having a curved part in the etching step, thereby forming the plurality of concave parts that are arranged in the circumferential direction.

8. The bonding method according to claim 1, further comprising a cover disposing step of covering at least a partial region excluding a part where the welding bonding part is formed, with a cover before the laser welding step, wherein a region not covered with the cover is irradiated with the energy beam in the etching step.

9. A manufacturing method for an electrical energy storage device, comprising the bonding method according to claim 1, wherein the electrical energy storage device includes the first member and the second member as constituent elements.

10. An electrical energy storage device comprising a first member made of a metal, a second member made of a metal, a welding bonding part of the first member and the second member, and a roughened part provided at a surface of the welding bonding part and its peripheral part, wherein the roughened part includes a plurality of concave parts with a substantially circular shape and is more concavo-convex than its periphery.

11. The electrical energy storage device according to claim 10, wherein the concave part has a diameter of 20 to 100 μm and a depth of 1 to 10 μm.

12. The electrical energy storage device according to claim 10, wherein the plurality of concave parts are disposed regularly.

13. The electrical energy storage device according to claim 10, wherein
the roughened part is provided in a substantially circular shape or an annular shape in a plan view, and
the plurality of concave parts are arranged in a circumferential direction.

14. The electrical energy storage device according to claim 10, comprising:
an electrode body including a first electrode and a second electrode;
a case that accommodates the electrode body;
a terminal electrically connected to the first electrode and attached to the case; and
a current collecting part that is disposed in the case and electrically connects the first electrode and the terminal, wherein
the first member is the terminal, and
the second member is the current collecting part.
